(19) United States
(12) Patent Application Publication
(10) Pub. No.: US 2005/0246238 A1
(43) Pub. Date: Nov. 3, 2005

(54) Item of interest marking and posting system and method

(75) Inventor: Joseph L. Dvorak, Boca Raton, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/833,528

(22) Filed: Apr. 28, 2004

(51) Int. Cl. G06F 17/60

(52) U.S. Cl. 705/26

(57) ABSTRACT

A list generation system (300) and method that includes cellular phone/item selector (102) that reads an identifier (106, 108) of a selected item the user is interested in receiving as a gift. The cellular phone/item selector (102) includes a GPS receiver (818) to determine a location near the selected item. An identification of the selected item is then added, along with the location of the item and the user's identification, to a list (700) that is accessible to gift givers. Once a gift is received by the user, the cellular phone/item selector is used to scan the identifier of the item (106, 108) and the item is removed from the list (700). An embodiment maintains the list (700) on a server (308) and makes the list (700) available over the World Wide Web.

### FIELD OF THE INVENTION

The present invention generally relates to the field shopping aids and more specifically to the field of wish list generators.

### BACKGROUND OF THE INVENTION

Wish lists, which are lists of items and/or services that an individual desires to receive as gifts, allow an individual to share a specific list of things that would be appreciated as gifts. Wish lists are frequently useful during gift giving events, such as weddings, birthdays and some holidays when gifts are to be given or exchanged. Creating and distributing wish lists is often a difficult task. Some retailers have “gift registries” that allow a person to register items he or she wishes to receive and others can access this list and purchase those items. A difficulty in using retailer gift registries is that gift givers have to know with which retailer or retailers the intended recipient has registered. An intended recipient is able to register wish lists with several retailers, thereby requiring gift givers to know and then visit the several retailers with which the intended recipient has registered.

Creating a wish list at one or more retailers that have gift registries can also be inconvenient for the intended recipient. An intended recipient is required to look through catalogs or walk through the store with a special device that allows him or her to scan bar codes for desired items. The use of the special device generally restricts gift registration to special trips where the intended recipient is focused on selecting future gifts, which can be a time consuming process. When not specifically creating a wish list, individuals frequently are just shopping or browsing in a store and happen find something in which he or she is interested in receiving as a gift, but don't have any way of noting that interest. It might be difficult to remember the item for later inclusion in a wish list and registering with the retailer at that time might be too burdensome and/or time consuming to just indicate that one item. In such situations, the individual is not currently generating a wish list, but sees something that would be desired. A further impediment to noting the item for inclusion in a wish list is that the next gift giving event, such as for his or her birthday or holiday, might be many months away and the item is forgotten before it is time to generate a wish list.

Therefore a need exists to overcome the problems with the prior art as discussed above.

### SUMMARY OF THE INVENTION

According to an embodiment of the present invention, a method for maintaining a desired item list includes determining a location of a selection device operated by a first user and determining, by the selection device operated by the first user, an identification of an item that is substantially near the location. The method further includes determining a seller of the item based upon the location and storing, in association with the first user, an identification of the seller of the item and the identification of the item in an accessible database. The method also includes communicating a list of items to a second user, the list comprising information based upon the identification of the item and the identification of the seller.

In a further aspect of the present invention, an item list generator includes a selection device that has a geographic locator that determines a location of a selection device that is operated by a first user and that also has an information scanner that determines an identification of an item that is substantially near the location. The item list generator further includes a geo-locator that determines a seller of the item based upon the location, a selected item database that stores, in association with the first user, an identification of the seller of the item and the identification of the item in an accessible database, and a list communicator that communicates a list of items to a second user, the list comprising information based upon the identification of the item and the identification of the seller.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a user handset and product tags according to an exemplary embodiment of the present invention.

FIG. 2 illustrates an exemplary geographical map of a region used by a cellular phone/item selector according to an exemplary embodiment of the present invention.

FIG. 3 illustrates an intercommunications diagram that illustrates communications between and among the various components of an exemplary embodiment of the present invention.

FIG. 4 illustrates a product identification packet as communicated from a cellular phone/item selector to a server in an exemplary embodiment of the present invention.

FIG. 5 illustrates a server block diagram including server according to an exemplary embodiment of the present invention.

FIG. 6 illustrates a selected item database as stored within a server of an exemplary embodiment of the present invention.

FIG. 7 illustrates a personal World Wide Web page display as produced by an exemplary embodiment of the present invention.

FIG. 8 illustrates a cellular phone/item selector block diagram of a cellular phone/item selector according to an exemplary embodiment of the present invention.

FIG. 9 illustrates a product identification packet reception processing flow diagram as performed by an exemplary embodiment of the present invention.

FIG. 10 illustrates a process purchased item processing flow as is performed by an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention is a system and method that allow an individual to select an item and record his or her interest in that item. Annotations for that item can be added that further describe the item and its geographical location when it was selected by the individual. An electronically available list, such as on a World Wide Web site, is also created that contains a description of all of the items selected by that individual. Some embodiments of the present invention include equipment in a cellular phone/item selector that is able to automatically capture identifications of items selected by a user. These identifications are then transmitted with the user's identity and a location of the item to a central server for inclusion on the “wish list” web page associated with the particular user. Items listed on the wish list in these embodiments of the present invention can advantageously be located in any retailer. The individual of the exemplary embodiment of the present invention is not required to register with the retailer, nor is the retailer required to maintain a registry system or be a participant in any central registry system. Items in the exemplary embodiments are identified by common identifiers, such as Universal Product Codes (UPCs) and retailers are identified on the wish list by geographic location, such as street address and/or retailer name. The wish list generated by embodiments of the present invention is able to persist for long periods of time and is not tied to particular gift giving events, such as holiday or birthdays. The wish list created by the exemplary embodiments of the present invention are further maintained in a single location, such as a dedicated web page, so that gift givers always know they can access this single, complete, and updated list of desired items anytime of the year.

The exemplary embodiments advantageously incorporate a product scanner into a compact cellular- phone so as to allow an individual to carry this combined device with him or her at all times. This allows the individual to select, capture and add to his or her wish list an identification and location of a desired item anytime that individual sees the item in a store or other retail establishment. This advantageously increases usability and convenience of use as compared to prior art systems that require a special device to be obtained and carried during more-or-less dedicated “shopping list capture” store visits.

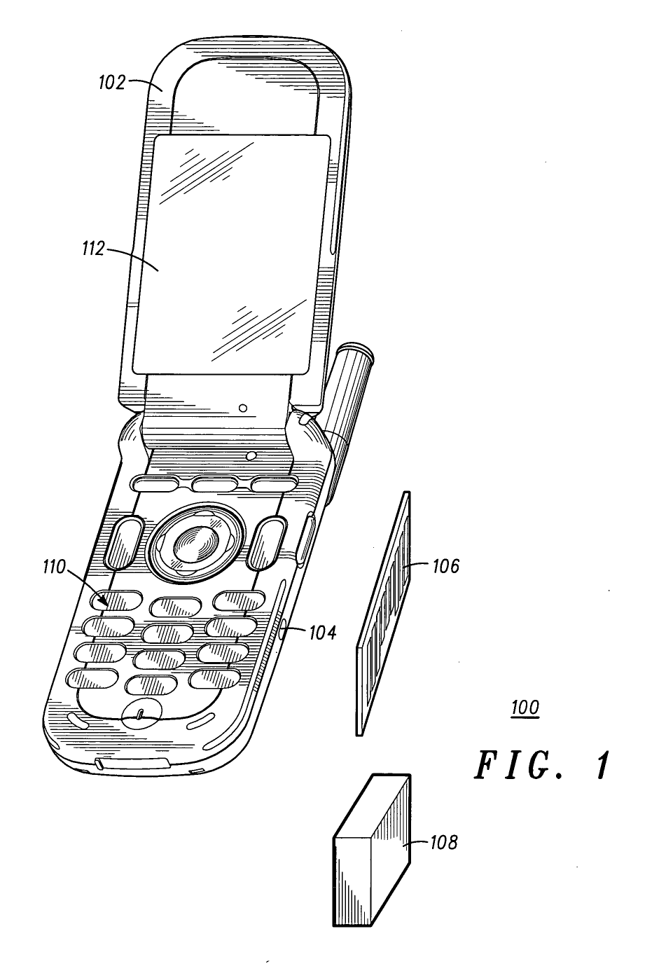

FIG. 1 illustrates a user handset and product tags 100 according to an exemplary embodiment of the present invention. A cellular phone/item selector 102 is a selection device that is a combination conventional cellular telephone that further incorporates a product scanner 104. Also shown in the user handset and product tags 100 are product identifiers, including an example printed bar code 106 and an example Radio Frequency Identification (RFID) tag 108, that contain an identification of the item. RFID tags are often referred to as “Smart Tags” since some versions can be programmed with significant amounts of information. Exemplary RFID tags 108 are able to be programmed with only a Universal Product Code (UPC), which is the data typically encoded onto a printed bar code 106. Other RFID tags allow further product information to be stored into the RFID tag 108. Some RFID tags 108 are able to be reprogrammed with information at any time, such as at a point of sale. The product scanner 104 of the exemplary embodiment is a multiple scanner device that is able to either optically scan printed bar codes 106 or interrogate and retrieve information from various types of RFID tags 108. Some embodiments of the present invention include an RFID programmer within product scanner 104.

The cellular phone/item selector 102 has a keypad 110 and display 112. The keypad 110 of the exemplary embodiment includes a conventional cellular telephone keypad that has an additional button that is defined and labeled as “ITEM SELECT” that when pressed, cause the product scanner 104 to scan identification tags, such as printed bar code 106 or RFID tag 108; store; process; and transmit the item identifier and possibly other data as is described below. Display 112 of the exemplary embodiment is an alphanumeric and graphical display that allows information about the selected product to be displayed to the user, as is described below.

FIG. 2 illustrates an exemplary geographical map 200 of a region used by a cellular phone/item selector 102 according to an exemplary embodiment of the present invention. The exemplary geographical map 200 includes two north-south streets, Main Street and Oak Street, and three east-west streets, 1^{st}, 2^{nd}, and 3^{rd} Streets. Four particular retailers are also indicated; Store 1 North 202 and Store 1 South 204 are two store locations of the same retail chain. Store 2 206 and store 3 208 are stores for two other retailers, which may or may not be part of a retail chain. The exemplary geographical map 200 illustrates the general location for these four retail stores relative to the illustrated streets.

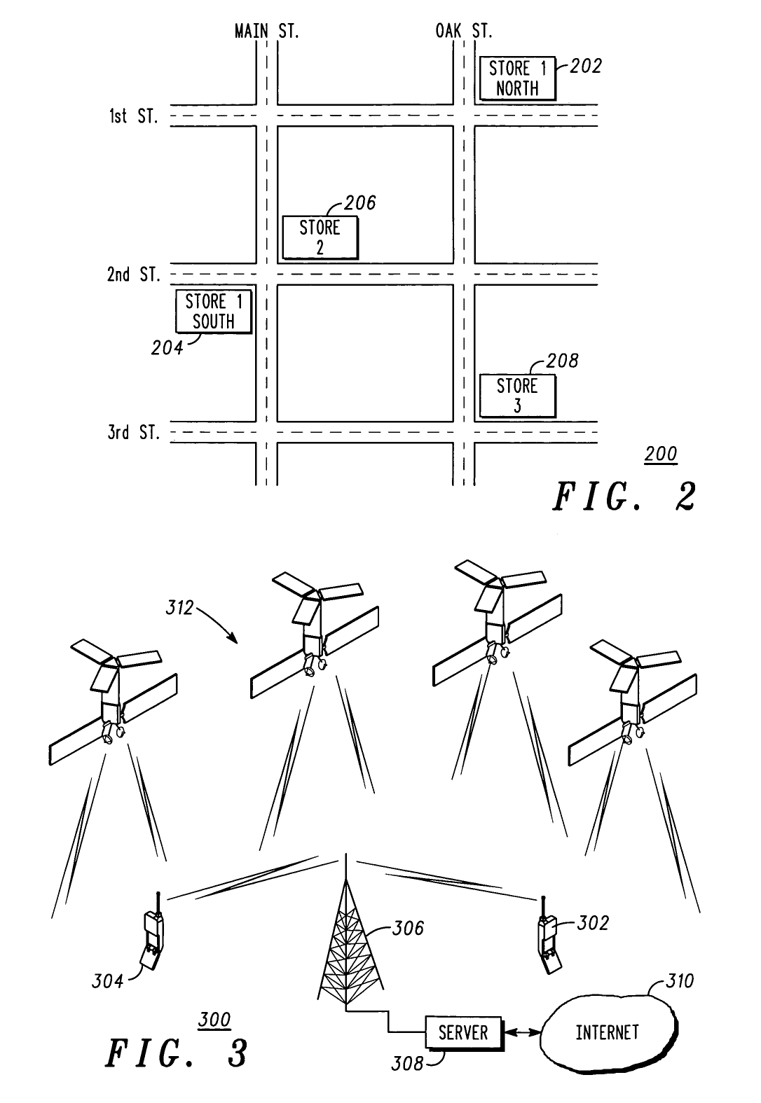

FIG. 3 illustrates an intercommunications diagram 300 that illustrates communications between and among the various components of an exemplary embodiment of the present invention. The intercommunications diagram 300 illustrates two cellular phone/item selectors, Selector A 302 and Selector B 304. Selector A 302 and Selector B 304 are similar to the cellular phone/item selector 102 discussed herein. Selector A 302 and Selector B 304 communicate over a terrestrial radio link to a base station 306. Selector A 302 and Selector B 304 of the exemplary embodiment communicate voice and data over conventional cellular or other terrestrial radio links to the base station 306.

Selector A 302 and Selector B 304 of the exemplary embodiments utilize various geo-position techniques to determine the latitude and longitude of the selector device. The intercommunications diagram 300 illustrates a radio navigation system that includes Global Positioning System (GPS) satellites 312 that transmit signals to GPS receivers within the selectors (described below) to allow Selector A 302 and Selector B 304 to determine their respective geographic locations. However, any other suitable location mechanism could be used.

Selector A 302 and Selector B 304 continually determine their geographic location and store the last determined location for the device. These selectors further allow a user to scan a machine readable identifier of an item, such as printed bar code 106 or RFID tag 108, and store information determined during that scanning. These selectors then communicate to the base station 306 the determined product identification, the selector location and an identification of the selector device, which is used to determine the identity of the user of that selector device. The product identification, selector location and selector device identification are relayed to the server 308. Server 308 stores and processes this information as is described herein. Server 308 of the exemplary embodiment is connected to electronic communications media, such as Internet 310, thereby allowing remote users to access data stored on the server, such as the product identification, selector location and selector device identification/user identification for items selected and identified by individual users.

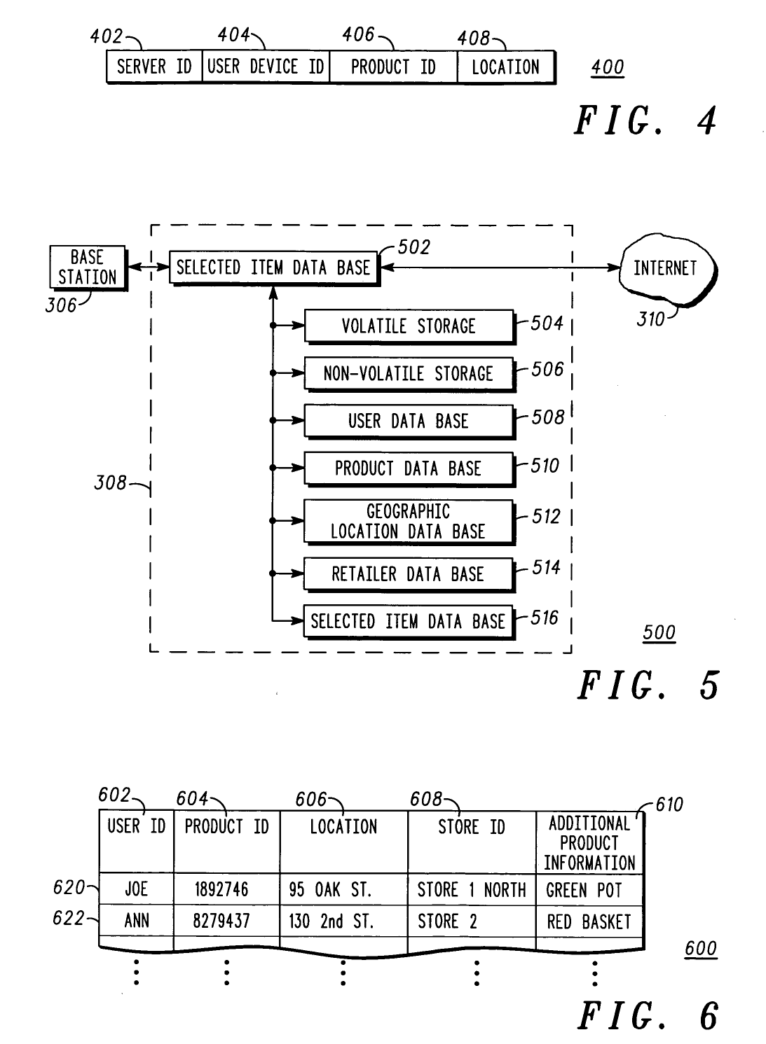

FIG. 4 illustrates an exemplary embodiment of product identification packet 400 as communicated from a cellular phone/item selector 102 to a server 308 in an exemplary embodiment of the present invention. The product identification packet 400 is a data packet that is communicated according to a protocol that is defined for the cellular phone or other terrestrial data link network used by the particular embodiment.

Product identification packet 400 includes a Server ID field 402. Server ID field 402 includes an identification of the server 308 that is to receive this data packet. The Server ID field 402 is able to contain any type of identification, such as an Internet Protocol (IP) address of server 308, a system specific identifier or other identification and/or routing data. The Server ID field 402 can also include an indication that this packet contains selected item data.

The product identification packet 400 further contains a User Device ID field 404 that includes an identification of the particular user device being used as an item selector. The User Device ID field 404 is able to include any device identification number, such as a cellular telephone number, a unique wireless communications device identification number, and the like. Servers in exemplary embodiments of the present invention accept the data in the User Device ID field 404 and correlate that data to a particular individual according to data stored by an operator of the exemplary embodiment.

The product identification packet 400 also contains a Product ID field 406 that contains an identification of the item selected and scanned by the user of the cellular phone/item selector 102 of the exemplary embodiment. The Product ID field 406 of the exemplary embodiment generally contains the Universal Product Code (UPC) of the scanned item. Alternative embodiments contain other information as well as augmented information obtained from an RFID tag 108 or from data stored in other databases. The product identification packet 400 further contains a Location field 408. The Location field 408 of the exemplary embodiment includes the last determined latitude and longitude of the cellular phone/item selector prior to scanning the product of interest that corresponds to the data in the Product ID field 406. Some embodiments of the present invention include location information derived by different or additional systems, including location information within the retail store where the item was scanned. Determination of a devices location within the store is able to be determined by various systems known to ordinary practitioners in the relevant arts.

FIG. 5 illustrates a server block diagram 500 including server 308 according to an exemplary embodiment of the present invention. Server 308 has a processor 502 that is a programmable data processor, such as a computer or other data processing device, that is programmed to perform functions in support of the operation of the exemplary embodiment of the present invention. Processor 502 is in communicative contact with base station 306 and the internet 310, as described herein.

Processor 502 has access to volatile storage 504 that is used to store temporary data used in the computations and operation of processor 502. Volatile storage of the exemplary embodiment includes Random Access Memory (RAM) and other technologies used to provide access to volatile data. Processor 502 further has access to non-volatile storage 506 that is used to store programs and more permanent, but changeable, data for the operation of processor 502. Non-volatile storage 504, among other things, either includes or is used to store program data obtained from a computer readable medium that is executed by processor 502.

In addition to the storage described above, server 308 of the exemplary embodiment maintains a number of databases. Databases maintained by server 308 of the exemplary embodiment are used to augment, enhance or modify user, retailer and/or item data received for selected items from an item selector, such as cellular phone/item selector 102.

User database 508 contains data related to individual users of the system of the exemplary embodiment. The User database 508 includes a mapping to determine a user's identity from the device identifier, such as cell phone numbers, communicated in the User Device ID field 404 of the product identification packet 400. User data stored in the User database 508 include, for example, the user's name, address and a reference to a World Wide Web page, as is discussed below, that lists and possibly describes items selected by the user.

Product database 510 contains data about products, items and services that can be selected by users of the exemplary embodiments. The product database 510 includes data related to items and products, such as product names, colors, photos or images, descriptions, and the like. The product database 510 of the exemplary embodiment accesses product and item information based upon data communicated in the Product ID field 406 in product identification packets 400 of the exemplary embodiment. Data stored within the Product database 510 is used, for example, to enhance product descriptions shown on user selected product World Wide Web pages, described herein.

Server 308 further maintains a Geo-location database 512. The Geo-location database 512 supports determination of a street address for a particular geographic location given the latitude and longitude of that location. The geo-location database 512 is used by processing that determines the street address that corresponds to the geographical location contained in the Location field 408 of product identification packets 400. Such processing is used, for example, to determine the street address of a retailer, i.e., the seller, where the item selected by the user is located.

Server 308 also maintains a retailer database 514 that stores data about various retailers. Data in the Retailer Database 514 is stored according to one or more of the geographic location communicated in the Location field 408 of product identification packets 400 or according to the street address retrieved from the geo-location database 512. Retailer database 514 is further able to store other data about retailers, such as hours of operation, other store promotions, and the like.

Server 308 further maintains a selected item database 516. The selected item database of the exemplary embodiment includes lists of items that were selected as desired gifts by users of selection devices. The selected item database 516 of the exemplary embodiment is an accessible database that is accessible to retrieve lists of selected items. The selected item database 516 is described in detail below.

FIG. 6 illustrates a selected item database 600 as stored within a server 308 of an exemplary embodiment of the present invention. The selected item database 600 includes information received in product identification packets 400 sent from item selectors, such as a cellular phone/item selector 102. The selected item database 600 of this exemplary embodiment further incorporates information retrieved from other databases, such as databases maintained by the server 308 or third party databases, that provide more detailed or user friendly information related to data communicated via product identification packets 400. The selected item database 600 has a number of rows with each row containing information for one selected item. Two exemplary rows are illustrated, Row A 620 and Row B 622. The selected item database 600 further has several columns that each contains certain data for each selected item. This exemplary selected item database 600 includes data for selected items from multiple individuals. Further embodiments of the present invention store selected item information for each user in different database tables. Data for a particular user, or subgroups of users, is able to be easily retrieved from the exemplary selected item database 600 through conventional database operations.

The user ID column 602 contains a description of the user who has selected an item. For example, Row A 620 indicates a User ID of “Joe” and Row B 622 indicates a User ID of “Ann.” Users' first names are illustrated here for simplicity and many embodiments of the present invention will store more detailed user identification information for each selected item. The data stored in the User ID column 602 of the exemplary embodiment is obtained from the received User Device ID field 404 of the product identification packet 400 that corresponds to this selected item. The exemplary embodiments of the present invention receive user device identification data in the User Device ID field 404 of the product identification packet 400, such as a cellular phone number, a unique device identification number or other device identification data. These exemplary embodiments maintain another database, such as the User database 508, that maps device identification data received in the User Device ID field 404 to more detailed and/or user friendly user identification information. The exemplary embodiments store data extracted from the User database 508 into the User ID column 602 of the exemplary embodiment.

A Product ID column 604 of the selected item database 600 stores a product identifier for the item selected by the user. The Product ID column 604 of the exemplary embodiment stores a Universal Product Code (UPC) for the selected item. Further embodiments are able to store additional data that is extracted from other databases, such as the Product database 5 10 or external databases maintained by third parties, that contain information about items based upon UPC numbers or data retrieved from local or external databases. In these embodiments, the additional product information column 610 also contains item or product information that is retrieved from those data sources.

The location column 606 contains the street address of the retailer in which the item of interest that was selected by the user is located. This street address is derived from the geo-location processing based upon data in the geo-location database 512. The Store ID column 608 indicates which retailer outlet corresponds to the street address and/or the geographic location provided in the product identification packet 400 corresponding to this item. The Store ID field identifies not only the retailer chain, but which store of that chain is the store where the selected item was found. The data in the Store ID column 608 is retrieved from the Retailer database 514 in the exemplary embodiment. As used within this description, an identification of a seller includes a street address, name and other information about retailers where a user selects an item.

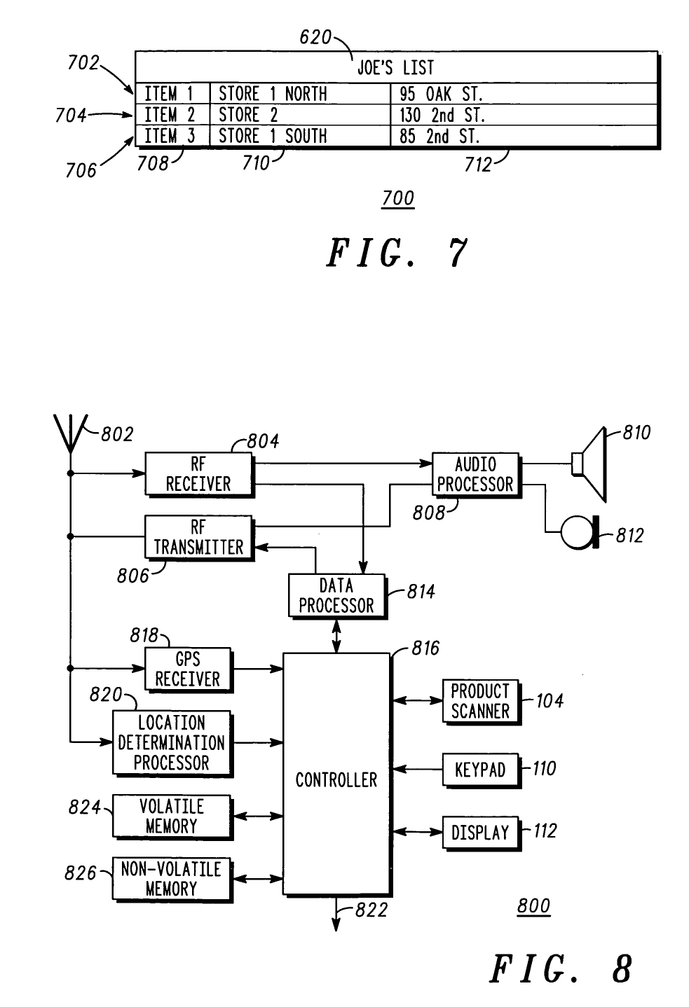

FIG. 7 illustrates a personal World Wide Web page display 700 as produced by an exemplary embodiment of the present invention. The personal World Wide Web page display 700 displays all items that have been selected by a particular user. The data within the personal World Wide Web page display 700 is extracted from the selected item database 600 by conventional database operations to extract rows corresponding to items selected by a particular user. The personal World Wide Web page display 700 is created by server 308 in the exemplary embodiment and transmitted to other computers via internet 310. The personal World Wide Web page display 700 is able to be accessed by any individual using a computer connected to the internet in order to determine items that a particular user has selected. Such a gift giver can access this personal World Wide Web page display 700 to identify a gift to give the particular user for the user's birthday, a special holiday or anytime the gift giver wants to give a gift to the particular user.

The personal World Wide Web page display 700 includes a title area 720 that indicates the particular user who has selected the listed items. Such a title area 720 is able to include photographs and/or other personal information. Below the title area 720 is a list of selected items. Each selected item is listed in its own row. Three exemplary rows are illustrated in the personal World Wide Web page display 700. Each row has three columns, an item identification column 708, a location column 710 and a street address column 712. Further embodiments are able to include columns with more detailed descriptions of the item and/or photographs of the item. The first row 702 illustrates a listing for “ITEM 1,” described in the item identification column 708. ITEM 1 is shown to be located in location “STORE 1N” that has a street address of “95 OAK STREET” as is contained in the location column 710 and the street address column 712, respectively. A second row 704 further describes “ITEM 2” is located at “STORE 2” at “130 2^{nd} STREET.” A third row 706 describes “ITEM 3” is located at “STORE 1S” at “85 2^{nd} STREET.”

FIG. 8 illustrates a cellular phone/item selector block diagram 800 of a cellular phone/item selector 102 according to an exemplary embodiment of the present invention. The cellular phone/item selector block diagram 800 includes a an RF antenna 802, an receiver 804 and RF transmitter 806. The RF transmitter 806 and RF receiver 804 are connected to the RF antenna 802 in order to support bi-directional RF communications. The cellular phone/time selector 102 is able to simultaneously transmit and receive voice and/or data signals to and from base station 308. The RF receiver 804 provides voice data to an audio processor 808 and the audio processor 808 provides voice data to the RF transmitter 806 to implement voice communications. The audio processor 808 obtains voice signals from microphone 810 and provides voice signals to speaker 812. The RF receiver 804, RF transmitter 806, Audio processor 808, microphone 810 and speaker 812 operate to communicate voice signals to and from the cellular phone/item selector 102 in manners similar to those used by conventional cellular phone.

The cellular phone/item selector block diagram 800 includes a controller 816 that controls the operation of the cellular phone/item selector in the exemplary embodiment. Controller 816 is connected to the various components of the cellular phone/item selector block diagram 800 via control bus 822. Controller 816 further performs processing within the cellular phone/item selector 102 to support operation of the exemplary embodiment of the present invention. Controller 816 communicates data to external devices, such as base station 106 and server 108, through a wireless link. Controller 816 provides data to and accepts data from data processor 814. Data processor 814 of the exemplary embodiment performs communications processing necessary to implement over-the-air data communications to and from external stations. Data processor 814 provides data for transmission to the RF transmitter 806 and accepts received data from RF receiver 804.

Controller 816 controls the operation of and accepts data from product scanner 104. Product scanner 104 of the exemplary embodiment includes an optical bar code scanner to scan printed bar codes 106. Product scanner 104 of the exemplary embodiment also includes an RFID tag reader to read RFID tags 108. Further embodiments have only one of these types of product scanners or yet further types of product scanners.

Controller 816 provides visual display data to the user through display 112. Display 112 of the exemplary embodiment is a Liquid Crystal Display that is able to display alphanumeric and graphical data. Controller 814 also accepts user input from keypad 110. Keypad 110 is similar to a conventional cellular phone keypad and has buttons to accept user input in order to support operation of the exemplary embodiment of the present invention. The keypad 110 of the exemplary embodiment has reprogrammable “softkeys” that operate in conjunction with visual prompts on display 112 to allow the user to activate product scanner 804 and scan a product tag in order to select a particular item. For example, cellular phone/item selector 102 has a top-level menu that has an entry “SCAN ITEM” and when this menu entry is selected, such as by highlighting that menu entry and pressing an “OK” key on the keypad 110, the controller causes the product scanner 104 to scan a tag and capture the item's identification and other data that is available on the item tag.

The cellular phone/item selector block diagram 800 further includes a GPS receiver 818 that determines the current geographical location of the cellular phone/item selector 102. The GPS receiver 818 of the exemplary embodiment continually provides its current location to controller 822, which stores the last determined location as determined by the GPS receiver 818. The location provided by the GPS receiver 818 is provided in the Location field 408 of the product identification packet 400.

Cellular phones used by some embodiments of the present invention also include software for determining locations indoors. An example includes the PINS (Portable Inertia Navigation System), which is a specific indoor location technology. Portable Inertia Navigation Systems and other systems used to determine locations within a store, such as the use of location beacons, are known to ordinary practitioners in the relevant arts.

The cellular phone/item selector block diagram 800 further includes non-volatile memory 826. Non-volatile memory 826 stores program data and more persistent data for use by controller 816. Data stored in non-volatile memory 826 of the exemplary embodiment can be changed under control of controller 816 if called for by particular processing performed by the controller 816. The cellular phone/item selector block diagram 800 further contains volatile memory 824. Volatile memory 824 is able to store transient data for use by processing and/or calculations performed by controller 816.

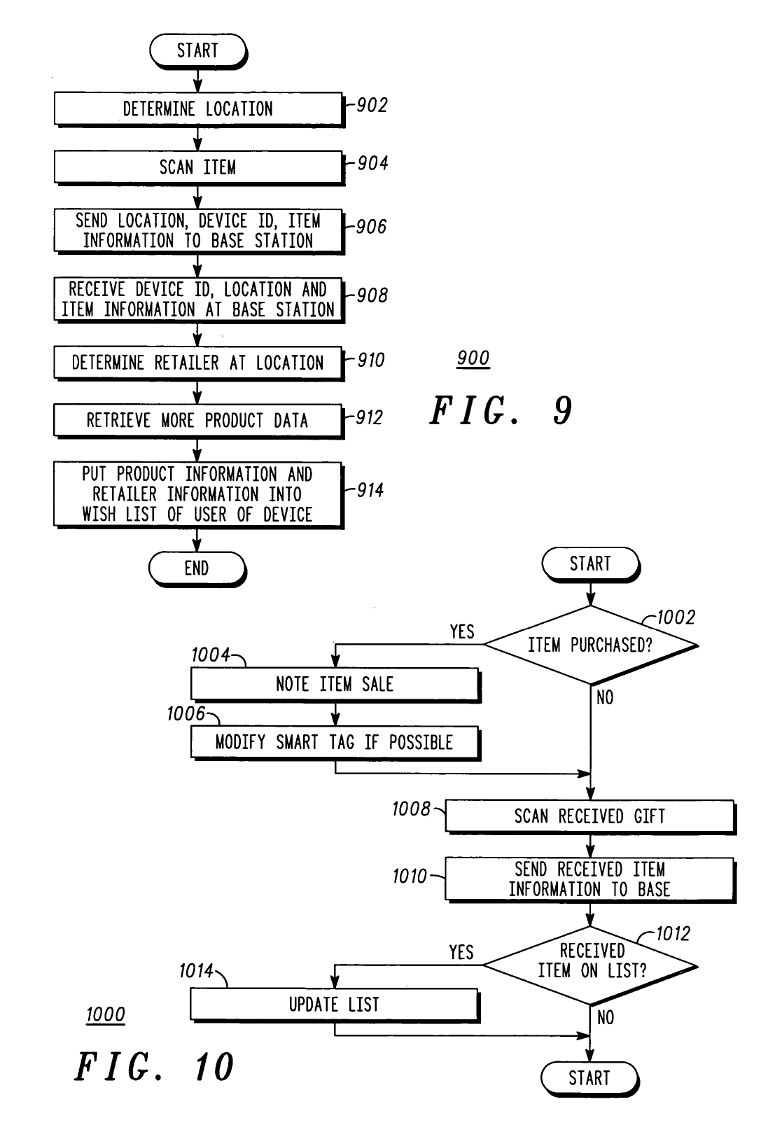

FIG. 9 illustrates a product identification packet reception processing flow diagram 900 as performed by an exemplary embodiment of the present invention. The top level processing begins by determining, at step 902, the current location of the cellular phone/item selector 102. This location is determined by use of any suitable location determination system, such as one or more of GPS receiver 818 and location determination processor 820. The processing then scans, at step 904, an item of interest that is selected by the user of the cellular phone/item selector 102. This scanning is performed by the product scanner 104 after being initiated in response to an input by the user. The processing then sends, at step 906, a product identification packet 400 that contains an identification of the device sending this packet along with the location and scanned item information that was determined in the above steps. In the exemplary embodiment, the above steps are performed by the cellular phone/item selector 102.

The processing continues by receiving, at step 908, the product identification packet 400, which contains the identification of the device sending this packet along with geographic location and scanned item information. This product identification packet 400 is received at the server 308 in the exemplary embodiment. The processing then determines, at step 910, the retailer that is located at the geographic location specified in the product identification packet 400. The retailer is determined in the exemplary embodiment by determining the street address of the received geographic location in conjunction with processing using the geo-location database 512. The retailer determination is further refined by determining a retailer identification that corresponds to the street address by retrieval of data stored in the retailer database.

The processing of the exemplary embodiment proceeds by retrieving, at step 912, more product data. Product data is retrieved from the product database 514 based upon the product identification data contained in the product identification packet 400. The processing then puts, at step 914, product information and retailer information into the wish list of the user using the item selector device that sent the product identification packet 400. The product identification packet reception processing flow then terminates.

FIG. 10 illustrates a process purchased item processing flow 1000 as is performed by an exemplary embodiment of the present invention. The process purchased item processing flow begins by determining, at step 1002, if an item has been purchased at a retailer. This purchase is noted in the exemplary embodiment by at the retailer's Point Of Sale (POS) system. If the item is determined to have been purchased, the processing advances by noting, at step 1004, the sale of the item. The processing then modifies, at the time of sale, a smart tag on the item to reflect this sale, if the item has a modifiable smart tag. Alternatively, the store's POS terminal could send the user's device an electronic itemized receipt. The user's identification device would read the receipt and store the items purchased.

After modifying the smart tag or if the item's purchase was not noted at a retailer's POS terminal, the processing advances by the user's scanning, at step 1008, a tag on an item received as a gift. This scanning is performed with an identification device, which is the same cellular phone/item selector used to select the device in the retailer. Other identification devices are similarly able to be used to perform this step. The tag is scanned so as to indicate that this item has been received as opposed to being selected as a desired gift. This is performed in the exemplary embodiment by pressing a key marked as “ITEM RECEIVED.”

The processing then sends, at step 1010, a description of the item to the server 308. This notification is formatted to identify that this is a notification that an item has been received. This notification further includes the product identification data that was scanned. The server 308 then determines, at step 1012, if the received item is listed on the user's selected item or wish list. If the received item is on the user's list, the list is updated by removing that item since the user has now received that item of interest. This updating allows received gifts to be noted and future gift givers have an updated list that does not contain items the user has already received. The processing then terminates.

The above described embodiments store selected items on a central server 308 and potential gift givers are able to access server 308 to determine gifts desired by an individual. Alternative embodiments operate to retain the list and retailer locations within the cell phone/item selector device itself. These embodiments store the item indicator, such as a UPC, and the retailer location in either volatile memory 824 or non-volatile memory 826. The user of the cell phone/item selector is then able to initiate sending this information to potential gift givers by wireless e-mail or other transmission mechanisms.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The terms “between” and “among” are not to be interpreted as limiting, the use of “between” alone is not to be interpreted as a term of limitation that restricts an action to only two objects, and the use of “among” alone is not to be interpreted as a term of limitation that excludes an action from operating upon only two objects.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method for maintaining a desired item list, the method comprising:
determining a location of a selection device operated by a first user;
determining, by the selection device operated by the first user, an identification of an item that is substantially near the location;
determining a seller of the item based upon the location;
storing, in association with the first user, an identification of the seller of the item and the identification of the item in an accessible database; and
communicating a list of items to a second user, the list comprising information based upon the identification of the item and the identification of the seller.

2. The method according to claim 1, wherein the determining an identification of an item comprises reading product information from a Radio Frequency Identification tag and further comprising the step of writing, at a time of sale of the item, sales data into the Radio Frequency Identification tag.

3. The method according to claim 1, wherein the storing is performed on the selection device and the communicating is initiated by the selection device.

4. The method according to claim 1, wherein the determining the location comprises determining a geographic location with a radio navigation system.

5. The method according to claim 4, wherein the determining the radio navigation system comprises a Global Positioning System.

6. The method according to claim 1, further comprising:
determining, by a device operated by the first user, an identification of a received item that is received by the first user;
determining if the identification of the received item is stored in the accessible database in association with the first user; and
removing from the database, in response to the determining that the identification of the received item is stored in the accessible database in association with the first user, the identification of the received item that is stored in association with the first user.

7. The method according to claim 6, wherein the identification device is the selection device.

8. The method according to claim 1, wherein the determining a seller of the item based upon the location comprises determining a street address that corresponds to the location.

9. The method according to claim 8, wherein the determining a seller of the item based upon the location further comprises determining a particular retailer based upon the street address.

10. An item list generator, comprising:
a selection device, comprising:
a geographic locator that determines a location of a selection device that is operated by a first user; and
an information scanner that determines an identification of an item that is substantially near the location;
a geo-locator that determines a seller of the item based upon the location;
a selected item database that stores, in association with the first user, an identification of the seller of the item and the identification of the item in an accessible database; and
a list communicator that communicates a list of items to a second user, the list comprising information based upon the identification of the item and the identification of the seller.

11. The item list generator according to claim 10, wherein the information scanner reads product information from a Radio Frequency Identification tag and further writes, at a time of sale of the item, sales data into the Radio Frequency Identification tag.

12. The item list generator according to claim 10, wherein the selected item database and the list communicator are contained within the selection device.

13. The item list generator according to claim 10, wherein the geographic locator comprises a Global Positioning System.

14. The item list generator according to claim 10, further comprising:
an identification device that determines, an identification of a received item that is received by the first user, and wherein the selected item database further
determines if the identification of the received item is stored in the accessible database in association with the first user; and
removes from the database, in response to determining that the identification of the received item is stored in the accessible database in association with the first user, the identification of the received item that is stored in association with the first user.

15. The item list generator according to claim 14, wherein the identification device is the selection device.

16. The item list generator according to claim 10, wherein the geo-locator determines a street address that corresponds to the location.

17. The item list generator according to claim 16, wherein the geo-locator further determines a particular retailer based upon the street address.

18. A computer program product comprising computer programming instructions for creating an item list, the computer programming instructions comprising instructions for:
determining a location of a selection device operated by a first user;
determining, by the selection device operated by the first user, an identification of an item that is substantially near the location;
determining a seller of the item based upon the location;
storing, in association with the first user, an identification of the seller of the item and the identification of the item in an accessible database; and
communicating a list of items to a second user, the list comprising information based upon the identification of the item and the identification of the seller.

19. The computer program product according to claim 18, further comprising instructions for
determining, by a device operated by the first user, an identification of a received item that is received by the first user;
determining if the identification of the received item is stored in the accessible database in association with the first user; and
removing from the database, in response to the determining that the identification of the received item is stored in the accessible database in association with the first user, the identification of the received item that is stored in association with the first user.
